(19) United States
(12) Patent Application Publication
(10) Pub. No.: US 2025/0343609 A1
(43) Pub. Date: Nov. 6, 2025

(54) WIRELESS TRANSMISSION DEVICE AND WIRELESS DISPLAY SYSTEM

(71) Applicant: LG ELECTRONICS INC., Seoul (KR)

(72) Inventor: Dongsung KIM, Seoul (KR)

(73) Assignee: LG ELECTRONICS INC., Seoul (KR)

(21) Appl. No.: 18/862,139

(22) PCT Filed: May 3, 2022
(86) PCT No.: PCT/KR2022/006329

§ 371 Date: Oct. 31, 2024

(51) Int. Cl. H04N 17/00; H04B 7/06; H04B 17/336

(52) U.S. Cl. CPC H04N 17/004; H04B 7/0608; H04B 17/336

(57) ABSTRACT

The present invention causes an optimal wireless signal to be transmitted between an A/V transmission device and an A/V reception device during the initial installation of a wireless display system according to the scenario and installation environment. The A/V transmission device may: acquire coverage data; determine the compression ratio of an image signal on the basis of the acquired coverage data; determine one or more configuration parameter values corresponding to the determined compression ratio; and configure a plurality of transmission antennas according to the one or more determined parameter values.

### TECHNICAL FIELD

The present disclosure relates to a wireless system for transmitting and receiving A/V data wirelessly.

### BACKGROUND ART

Digital TV services using wired or wireless communication networks are becoming common. The digital TV services may provide various services that cannot be provided by existing analog broadcasting services.

For example, in the case of IPTV (Internet Protocol Television) and smart TV services, which are types of digital TV services, interactivity is provided so that users can actively select the types of programs to watch, the viewing time, and the like. IPTV and smart TV services may provide various additional services, such as Internet search, home shopping, online games, etc., based on such interactivity.

Recently, TV services are provided through wireless systems in which A/V transmission devices transmit compressed A/V (Audio/Video) signals to A/V reception devices via wireless connections, and A/V reception devices restore the compressed A/V signals and output the restored A/V signals.

In the case of wireless systems, RF (Radio Frequency) communication is performed between A/V transmission devices and A/V reception devices via antennas, so the placement position relationship between transmission antennas and reception antennas is important for wireless quality.

In the past, when installing a wireless system initially, the user adjusts the antenna direction by checking the signal status of the A/V reception device. Specifically, the user changes the direction of the antenna to find the optimal signal condition depending on the distance between the A/V transmission device and A/V reception device.

When changing the direction of the antenna to find the optimal condition, the installation may be performed under conditions in which the image compression ratio or transmission power strength is not optimized.

Under these conditions, the image compression ratio may be maintained below the standard image quality, making it difficult to view the image at optimal quality, and the transmission power intensity may also increase compared to the standard power, causing problems when used under conditions with a high load.

### DISCLOSURE

### Technical Problem

The purpose of this disclosure is to transmit an optimal wireless signal according to the installation environment and scenario between an A/V transmission device and an A/V reception device during the initial installation of a wireless display system.

The purpose of this disclosure is to transmit default values such as compression ratio and signal strength when included within the optimal coverage or within a designated coverage during the initial installation of a wireless display system, thereby speeding up and optimizing the initial setup.

### Technical Solution

A wireless transmission device according to an embodiment of the present disclosure may include a compression chip that compresses an image signal, a plurality of transmission antennas, and a processor configured to obtain coverage data, determine a compression ratio of the image signal based on the obtained coverage data, determine values of one or more setting parameters corresponding to the determined compression ratio, and set the plurality of transmission antennas according to the determined values of one or more parameters.

A wireless display system including a wireless transmission device and a wireless reception device according to an embodiment of the present disclosure, the wireless transmission device is configured to obtain coverage data, determine a compression ratio of the image signal based on the obtained coverage data, determine values of one or more setting parameters corresponding to the determined compression ratio, set a plurality of transmission antennas according to the determined values of the one or more setting parameters, and transmit a compressed image signal to the wireless reception device using the values of the one or more setting parameters, and the wireless reception device is configured to restore the compressed image signal and display an image based on the restored image signal.

### Advantageous Effects

According to an embodiment of the present disclosure, when initially installing a wireless display system, the initial setup between an A/V transmitting device and an A/V reception device can be fast and optimized.

According to an embodiment of the present disclosure, when initially installing a wireless display system, the initial setup can be fast and optimized by transmitting default values such as compression ratio, signal strength, etc. when included within the optimal coverage or within the designated coverage.

### DESCRIPTION OF DRAWINGS

FIGS. 1 to 2 are drawings explaining the configuration of a display system according to an embodiment of the present disclosure.

FIG. 3 is a block diagram explaining the configuration of a remote control device according to an embodiment of the present disclosure.

FIG. 4 is a ladder diagram explaining the operation method of a wireless display system according to an embodiment of the present disclosure.

FIG. 5 is a flowchart explaining a process of determining the number of transmission antennas according to a determined compression ratio.

FIGS. 6 and 7 are drawings showing examples of mapping tables according to an embodiment of the present disclosure.

FIG. 8 is a drawing explaining an area where the compression ratio of A/V content can be 1/6 or more according to an embodiment of the present disclosure.

FIG. 9 is a drawing explaining a guide image that guides an initial position during initial setup of an A/V transmission device according to an embodiment of the present disclosure.

### BEST MODE

The video/audio (hereinafter, A/V) transmission device according to the embodiment of the present disclosure is, for example, an intelligent device that adds a computer support function to the broadcast reception function, and while remaining faithful to the broadcast reception function, it can have an Internet function, etc., and can have a more convenient interface such as a manual input device, a touch screen, or a space remote control.

In addition, it can perform functions such as email, web browsing, banking, or games by connecting to the Internet and a computer with the support of a wired or wireless Internet function. A standardized general-purpose OS can be used for these various functions.

Therefore, the A/V transmission device described in the present disclosure, can perform various user-friendly functions, for example, since various applications can be freely added or deleted on a general-purpose OS kernel.

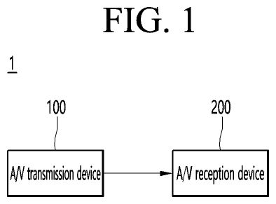

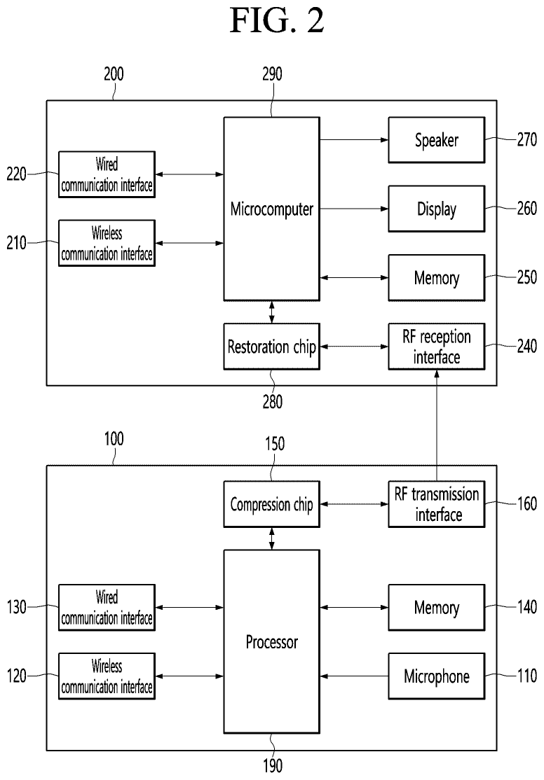

FIGS. 1 and 2 are drawings explaining the configuration of a wireless display system according to an embodiment of the present disclosure.

Referring to FIG. 1, a wireless display system 1 according to an embodiment of the present disclosure includes an A/V transmission device 100 and an A/V reception device 200.

The wireless display system 1 may be a system in which the A/V transmission device 100 wirelessly transmits A/V data to the A/V reception device 200, and the A/V reception device 200 outputs A/V data.

The A/V transmission device 100 may be a device capable of encoding video and audio and wirelessly transmitting encoded content image and audio.

The A/V transmission device 100 may be a set-top box.

The A/V transmission device 100 may be connected to an external device such as a set-top box or a USB memory. The A/V transmission device 100 can transmit an image signal or audio signal received from a connected external device to the A/V reception device 200.

The A/V reception device 200 can be a display device that wirelessly receives encoded images and audio and performs decoding of the received images and audio.

The A/V transmission device 100 and the A/V reception device 200 can configure a video wall display system.

In a video wall, having a display with a thin bezel plays an important role in visualizing content images. In order to have a thin bezel of the display, it is efficient to have only components that can play a minimum role, and to have circuits or components for main functions performed in a separate device.

The A/V transmission device 100 can determine a type of content image input from the outside, and determine the compression ratio of the content image based on the determined type. The compression ratio of content image can be defined as the ratio of the size of video data before encoding to the size of video data after encoding.

The type of content image can include still image type, general video type, and game video type.

The A/V transmission device 100 can compress a content image according to a determined compression ratio and transmit the compressed content image wirelessly to the A/V reception device 200.

The A/V reception device 200 can restore the compressed content image received from the A/V transmission device 100 and display the restored content image on a display.

FIG. 2 is a block diagram illustrating a detailed configuration of the A/V transmission device 100 and the A/V reception device 200.

Referring to FIG. 2, the A/V transmission device 100 can include a microphone 110, a wireless communication interface 120, a wired communication interface 130, a memory 140, a compression chip 150, an RF transmission interface 160, and a processor 190.

The microphone 110 can receive an audio signal and transmit it to the processor 190.

The microphone 110 can receive a voice spoken by a user.

The wireless communication interface 120 can include one or more of a Wi-Fi module and a Bluetooth module.

The Wi-Fi module can perform wireless communication with an external device or an A/V reception device 200 through the Wi-Fi standard.

The Bluetooth module can perform wireless communication through the Bluetooth Low Energy (BLE) standard.

The Bluetooth module can perform wireless communication with an external device such as a remote control device or an A/V reception device 200 through the Bluetooth Low Energy (BLE) standard.

The wireless communication interface 120 may be equipped with a tuner for receiving a broadcast signal.

The wired communication interface 130 may be an interface for a wired connection with an external device. The wired communication interface 130 may include multiple HDMI (High Definition Multimedia Interface) terminals or USB (Universal Serial Bus) ports.

The wired communication interface 130 may receive an image signal or an audio signal from an external device.

The memory 140 may store a program for signal processing and control, and may store a processed image, voice, or data signal.

The memory 140 may perform a function for temporary storage of an image, voice, or data signal input from an external source, and may store information about a given image through a channel memory function.

The compression chip 150 can compress an image signal or audio signal input from the external source and transmit the compressed signal to the RF transmission interface 160.

The compression chip 150 can have an encoder for compressing the image signal or audio signal.

The RF transmission interface 160 can transmit an A/V signal to the RF reception interface 240 of the A/V reception device 200 through RF (Radio Frequency) communication.

The RF transmission interface 160 can include one or more antennas.

The RF transmission interface 160 can transmit a compressed A/V signal in digital form to the RF reception interface 240.

The RF transmission interface 160 can transmit an A/V signal to the RF reception interface 240 through one or more channels.

The processor 190 can control the overall operation of the A/V transmission device 100. The processor 190 may be named as a Main System on Chip (Main SoC).

The processor 190 may include a compression chip 150.

The A/V reception device 200 may include a wireless communication interface 210, a wired communication interface 220, an RF reception interface 240, a memory 250, a display 260, a speaker 270, a restoration chip 280, and a microcomputer 290.

The wireless communication interface 210 may include a Wi-Fi module, a Bluetooth module, and an IR module.

The Wi-Fi module may perform wireless communication through the Wi-Fi standard.

The Wi-Fi module can perform wireless communication with an external device or A/V transmission device 100 through the Wi-Fi standard.

The Bluetooth module can perform wireless communication with a Bluetooth Low Energy (BLE) standard.

The Bluetooth module can perform wireless communication with an external device such as a remote control device or A/V transmission device 100 through the Bluetooth Low Energy (BLE) standard.

The IR module can receive a signal from a remote control device 300 described later through IR (Infrared) communication.

The wired communication interface 220 can be an interface for wired connection with an external device. The wired communication interface 220 can include a plurality of HDMI (High Definition Multimedia Interface) terminals or USB (Universal Serial Bus) ports.

The wired communication interface 220 can receive an image signal or an audio signal from an external device.

The RF reception interface 240 can receive a compressed A/V signal from the RF transmission interface 160.

The RF reception interface 240 can include a plurality of antennas. The RF reception interface 240 can be arranged at the bottom of the display 260.

The RF reception interface 240 can include a first antenna module and a second antenna module. Each of the first antenna module and the second antenna module can include a plurality of antennas.

The RF reception interface 240 can receive a compressed A/V signal in digital form from the RF transmission interface 160 and transmit the received A/V signal to the restoration chip 280.

The memory 250 can store a program for signal processing and control and can store a signal-processed image, voice, or data signal.

The display 260 can display an image signal received from the microcomputer 290.

The display 260 can display an image signal according to the operation of a timing controller (not shown).

The restoration chip 280 can restore a compressed A/V signal received by the RF reception interface 240. For this purpose, the restoration chip 280 can include a decoder.

The microcomputer 290 can control the overall operation of the A/V reception device 200.

The microcomputer 290 can output the restored image signal through the display 260 and output the restored audio signal through the speaker 270.

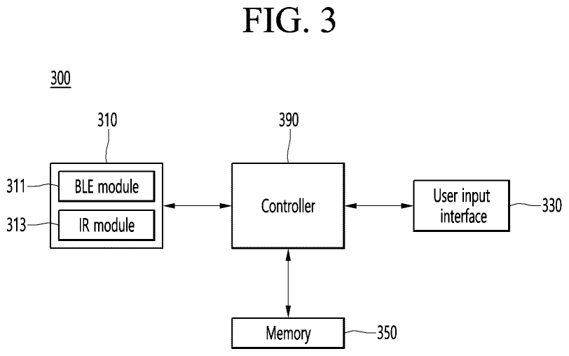

FIG. 3 is a block diagram illustrating a configuration of a remote control device according to an embodiment of the present disclosure.

Referring to FIG. 3, the remote control device 300 may include a wireless communication interface 310, a user input interface 330, a memory 350, and a controller 390.

The wireless communication interface 310 may be an interface for performing wireless communication with the A/V transmission device 100 or the A/V reception device 200.

The wireless communication interface 310 may include a Bluetooth Low Energy (BLE) module 311 and an InfraRed (IR) module 313.

The BLE module 311 may transmit a signal for controlling the operation of the A/V transmission device 100 to the A/V transmission device 100.

The BLE module 311 can transmit a signal to trigger pairing operation of A/V transmission device 100 to the A/V transmission device 100.

The user input interface 330 can be composed of keypad, button, touch pad, or touch screen.

The user input interface 330 can generate control command to control operation of the A/V transmission device 100 or the A/V reception device 200 according to operation command of user.

If the user input interface 330 has hard key button, user can operate hard key through push operation of hard key button.

The user input interface 330 can be equipped with various types of input means that user can operate, such as scroll key or jog key.

The memory 350 can store program for operation of controller 390 and can also temporarily store input/output data.

The controller 390 controls the operations associated with the application and, typically, the overall operation of the remote control device 300.

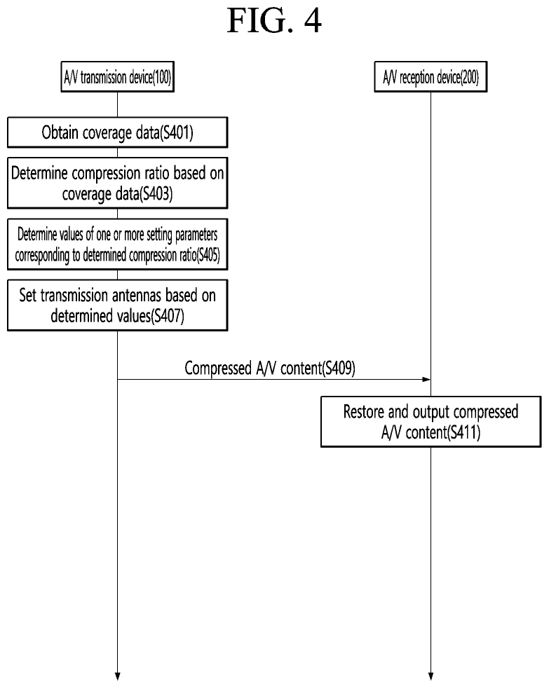

FIG. 4 is a ladder diagram for explaining an operation method of a wireless system according to an embodiment of the present disclosure.

The processor 190 of the A/V transmission device 100 obtains a coverage data (S401).

In one embodiment, the coverage data may be data for determining a compression ratio of A/V content to be transmitted from the A/V transmission device 100 to the A/V reception device 200.

In one embodiment, the coverage data may include a signal-to-noise ratio (SNR).

The SNR may represent a relative ratio of the power of an A/V signal to the power of a noise signal.

The processor 190 of the A/V transmission device 100 may receive the SNR from the A/V reception device 200. That is, the A/V reception device 200 can measure the SNR from the wireless signal including the noise signal and transmit the measured SNR to the A/V transmission device 100.

The processor 190 of the A/V transmission device 100 determines the compression ratio of the A/V content based on the obtained coverage data (S403).

In one embodiment, the memory 140 of the A/V transmission device 100 may store the compression ratio matching the coverage data in the form of a mapping table.

The mapping table may be a table that maps the corresponding relationship between a plurality of SNR values and a plurality of compression ratios.

When the processor 190 obtains the SNR value, it may read the compression ratio corresponding to the SNR value from the mapping table and determine the read compression ratio as the compression ratio of the A/V content.

In another embodiment, the mapping table may be stored in an external device or an external server that can communicate with the A/V transmission device 100.

The processor 190 may transmit an SNR value to the external device or the external server through the wireless communication interface 210, and receive a compression ratio corresponding to the SNR value from the external device or the external server.

The processor 190 of the A/V transmission device 100 determines values of one or more setting parameters corresponding to the determined compression ratio (S405).

In one embodiment, the setting parameter may be parameters for a plurality of transmission antennas provided in the RF transmission interface 160.

Specifically, the setting parameters may include one or more of the number of transmission antennas to be turned on among the plurality of transmission antennas, a gain of the plurality of transmission antennas, a transmission speed of the signal, and the RSSI (Received Signal Strength Indicator).

The fact that the transmission antenna is turned on may mean that power is supplied only to the corresponding transmission antenna, thereby transmitting the A/V signal to the A/V reception device 200.

The processor 190 may determine the value of the antenna parameter using a mapping table that maps the corresponding relationship between the compression ratio of the A/V content and the setting parameter.

The mapping table is described later.

The processor 190 of the A/V transmission device 100 sets a plurality of transmission antennas based on the values of one or more determined antenna parameters (S407).

The processor 190 can set a plurality of antennas based on the values of the determined antenna parameters.

Specifically, the processor 190 can turn on only the determined number of antennas among the plurality of transmission antennas.

As another example, the processor 190 can determine the gain values of the plurality of transmission antennas.

As another example, the processor 190 can turn on only some of the plurality of transmission antennas and determine the gain values of the turned-on transmission antennas.

The processor 190 of the A/V transmission device 100 transmits compressed A/V content to the A/V reception device 200 through the RF transmission interface 160 (S409).

The processor 190 can compress A/V content according to the determined compression ratio and transmit the compressed A/V content to the RF reception interface 240 of the A/V reception device 200 through the turned-on transmission antennas.

The microcomputer 290 of the A/V reception device 200 restores the compressed A/V content and outputs the restored A/V content (S411).

The embodiment of FIG. 4 is described in more detail below.

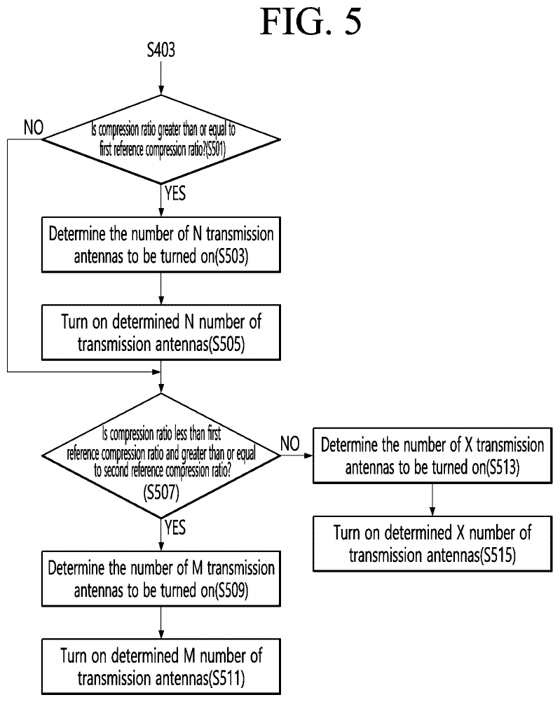

FIG. 5 is a flowchart explaining a process of determining the number of transmission antennas turned on according to the determined compression ratio.

Referring to FIG. 5, the processor 190 of the A/V transmission device 100 determines whether the compression ratio determined in step S403 is equal to or greater than a first reference compression ratio (S501).

The first reference compression ratio may be 1/6. A compression ratio of 1/6 may indicate that data is compressed at a ratio of 1/6 of the size of the original A/V data.

If the determined compression ratio is equal to or greater than 1/6, the position between the A/V transmission device 100 and the A/V reception device 200 may be determined to be appropriate. In other words, if the determined compression ratio is equal to or greater than 1/6, the A/V signal may be transmitted smoothly and the image quality may be good.

If it is determined that the determined compression ratio is less than or equal to the first reference compression ratio, the processor 190 of the A/V transmission device 100 determines the number of N transmission antennas to be turned on (S503).

The processor 190 of the A/V transmission device 100 turns on the transmission antennas as many as the determined number of N (S505).

The processor 190 of the A/V transmission device 100 determines whether the compression ratio determined in step S403 is less than the first compression ratio and greater than or equal to the second reference compression ratio (S507).

The second reference compression ratio may be 1/10.

If it is determined that the compression ratio determined in step S403 is less than the first compression ratio and greater than or equal to the second reference compression ratio, the processor 190 of the A/V transmission device 100 determines the number of M transmission antennas to be turned on (S509).

M may be greater than N.

The processor 190 of the A/V transmission device 100 turns on the transmission antennas as many as the determined number of M (S511).

If the compression ratio determined in step S403 is determined to be less than the second reference compression ratio, the processor 190 of the A/V transmission device 100 determines the number of X transmission antennas to be turned on (S509).

X may be greater than M.

According to an embodiment of the present disclosure, the number of transmission antennas to be turned on may vary depending on the determined compression ratio.

For example, as the determined compression ratio increases, the number of transmission antennas to be turned on may decrease, and as the compression ratio decreases, the number of transmission antennas to be turned on may increase.

Accordingly, during the initial setup of the wireless system, the optimal setup can be achieved depending on the position between the A/V transmission device 100 and the A/V reception device 200.

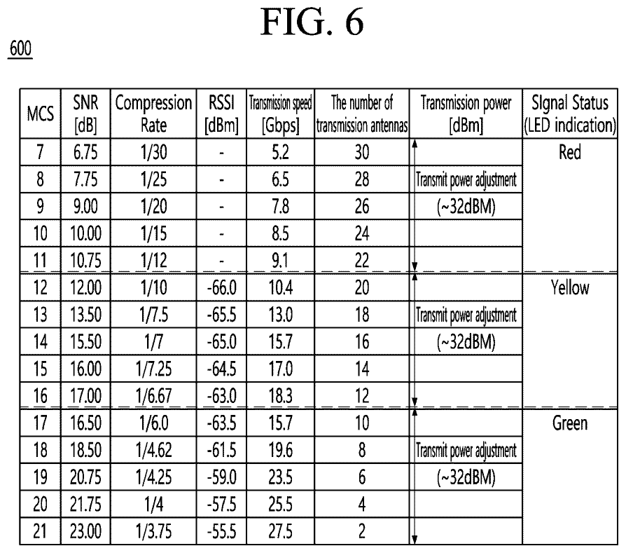

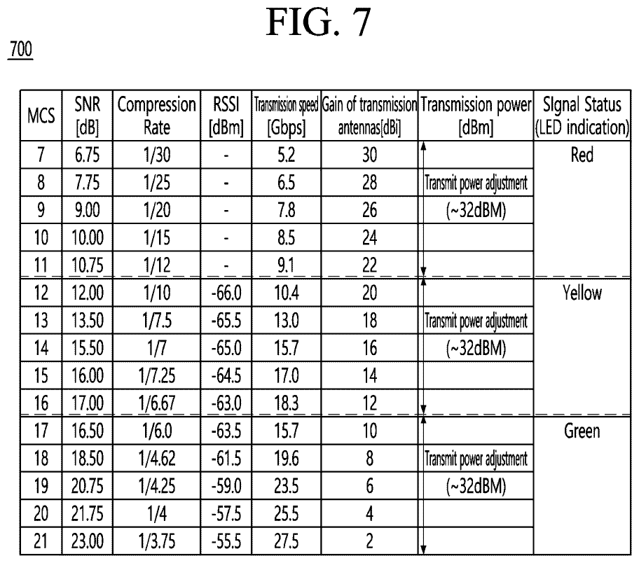

FIG. 6 and FIG. 7 are diagrams showing examples of mapping tables according to embodiments of the present disclosure.

The first mapping table 600 of FIG. 6 may be a table representing a mapping relationship between SNR, compression ratio (Compression Rate), RSSI, transmission speed, the number of transmission antennas to be turned on, and transmission power.

The second mapping table 700 of FIG. 7 may be a table representing a mapping relationship between SNR, compression ratio (Compression Rate), RSSI, transmission speed, gain of transmission antenna, and transmission power.

The first mapping table 600 and the second mapping table 700 may be stored in either the memory 140 of the A/V transmission device 100 or the memory 250 of the A/V reception device 200.

Meanwhile, when the SNR value is 10.75 [dB] or less, or when the compression ratio is 1/12 or less, the LED equipped in the A/V transmission device 100 may display a red color.

If the signal transmission quality is poor due to the distance between the A/V transmission device 100 and the A/V reception device 200 being too far or the direction being incorrect, the LED may display a red light.

When the SNR value exceeds 12.00 [dB] and is 17.00 [dB] or less, or when the compression ratio is 1/10 or more and 1/6.67 or less, the LED equipped in the A/V transmission device 100 may display a yellow color.

When the signal transmission quality between the A/V transmission device 100 and the A/V reception device 200 is in an intermediate state, the LED may display a yellow color.

When the SNR value is 16.50 [dB] or higher, or when the compression ratio is 1/6 or higher, the LED equipped on the A/V transmission device 100 may display green.

When the signal transmission quality between the A/V transmission device 100 and the A/V reception device 200 is good, the LED may display green.

Referring to FIG. 6, when the processor 190 obtains the SNR, the processor 190 can determine the compression ratio mapped to the SNR and the number of transmission antennas to be turned on using the first mapping table (600).

The processor 190 can compress the A/V content with the compression ratio matched to the SNR.

The processor 190 can transmit the compressed A/V content to the RF reception interface 240 of the A/V reception device 200 through N transmission antennas mapped to the compression ratio.

In another embodiment, when the processor 190 obtains the SNR, the processor 190 can determine the compression ratio, RSSI, transmission speed, and transmission power mapped to the SNR using the first mapping table 600.

Referring to FIG. 7, when the processor 190 obtains the SNR, it can determine the compression ratio and the gain of the transmission antenna mapped to the SNR using the second mapping table 700. At this time, the transmission antennas with adjusted gains may be all transmission antennas included in the RF transmission interface 160.

The processor 190 can compress the A/V content with the compression ratio matched to the SNR.

The processor 190 can transmit the compressed A/V content to the RF reception interface 240 of the A/V reception device 200 through the gain of the transmission antenna mapped to the compression ratio.

That is, the processor 190 can control the operation of a plurality of transmission antennas so that the compressed A/V content has the gain of the transmission antenna mapped to the compression ratio.

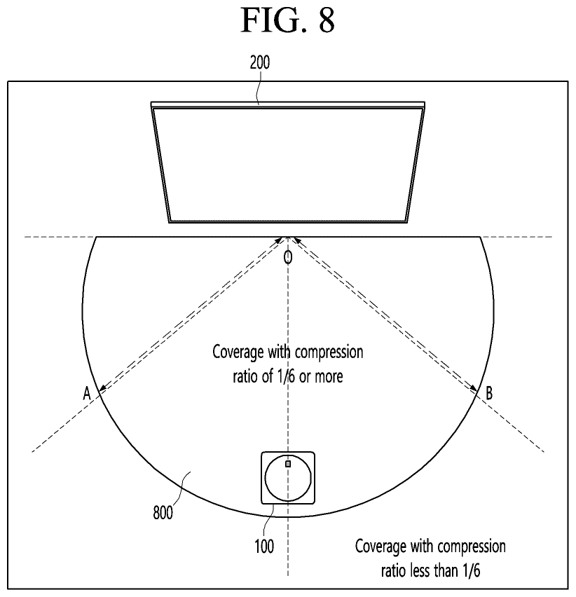

FIG. 8 is a drawing for explaining an area where the compression ratio of A/V content can be 1/6 or more according to one embodiment of the present disclosure.

Referring to FIG. 8, an A/V transmission device 100 and an A/V reception device 200 are illustrated. Generally, during initial setup, the position of the A/V reception device 200 may be determined first, and then the position of the A/V transmission device 100 may be determined.

The optimal condition for the compression ratio of A/V content to be 1/6 or more is the fan-shaped area 800 of the OAB, and the compression ratio of A/V content in other areas may be less than 1/6.

When the A/V transmission device 100 is located within a fan-shaped area 800 based on the position (O) of the A/V reception device 200, or when the A/V transmission device 100 is located outside the fan-shaped area 800, the A/V transmission device 100 can set one or more of the gains or the number of antennas to be turned on among a plurality of transmission antennas provided in the RF transmission interface 160 by referring to the first mapping table 600 or the second mapping table 700.

That is, according to the embodiment of the present disclosure, the values of the setting parameters may be automatically set according to the position of the A/V transmission device 100.

Accordingly, the user may set the settings of the wireless display system simply, easily, and quickly.

In addition, the values of the setting parameters may be automatically set according to the position where the A/V transmission device 100 is placed, so that the video can be viewed with optimized quality.

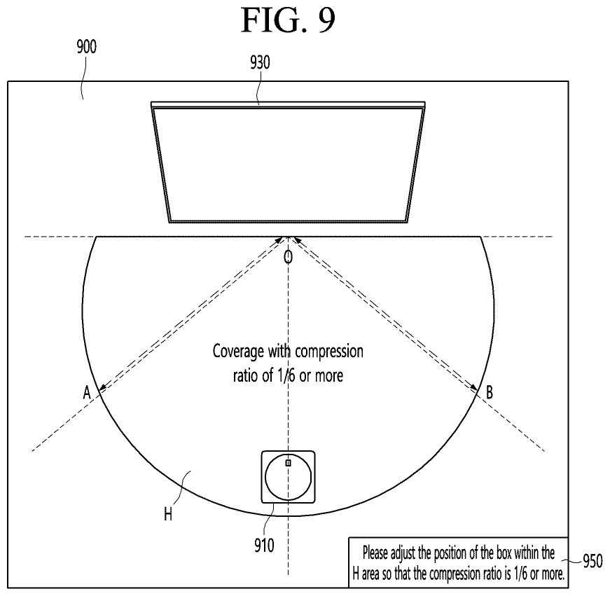

FIG. 9 is a drawing explaining a guide image for guiding an initial position during initial setup of an A/V transmission device according to an embodiment of the present disclosure.

The guide image 900 may be displayed on the initial screen of the A/V reception device 200.

The guide image 900 may be displayed according to a command received through the remote control device 300.

The guide image 900 may be displayed when the compression ratio of the A/V content of the A/V transmission device 100 is less than 1/6.

The guide image 900 may include a first image 910 corresponding to the A/V transmission device 100, a second image 930 corresponding to the A/V reception device 200, an area image (H) indicating a coverage with a compression ratio of 1/6 or more, and guide text 950.

The guide text 950 may include text to adjust the position of the A/V transmission device (100, or box) within the area of H so that the compression ratio becomes 1/6 or more.

The user can adjust the placement position of the A/V transmission device 100 within the area where the compression ratio becomes 1/6 or more through the guide image 900.

When the placement position of the A/V transmission device 100 is adjusted within the area where the compression ratio becomes 1/6 or more, the A/V transmission device 100 may automatically set the values of the setting parameters.

Accordingly, the initial setting of the wireless system may be performed quickly and optimally.

According to one embodiment of the present disclosure, the above-described method may be implemented as a code that can be read by a processor on a medium in which a program is recorded. Examples of the medium that can be read by a processor include a ROM, a RAM, a CD-ROM, a magnetic tape, a floppy disk, an optical data storage device, etc.

The display device described above is not limited to the configuration and method of the embodiments described above, and the embodiments may be configured by selectively combining all or part of each embodiment so that various modifications can be made.

1. A wireless transmission device, comprising:
a compression chip configured to compress an image signal;
a Radio Frequency (RF) transmission interface configured to include a plurality of transmission antennas and transmit the compressed image signal to a wireless reception device; and
a processor configured to obtain coverage data, determine a compression ratio of the image signal based on the obtained coverage data, determine values of one or more setting parameters corresponding to the determined compression ratio, and set the plurality of transmission antennas according to the determined values of one or more setting parameters,
wherein the one or more setting parameters includes the number of transmission antennas to be turned on among the plurality of transmission antennas, and
the processor is configured to determine the values of the setting parameters so that the number of transmission antennas to be turned on decreases as the determined compression ratio increases.

2. The wireless transmission device of claim 1, wherein the one or more parameters further a gain of the plurality of transmission antennas.

3. The wireless transmission device of claim 2, wherein the coverage data is Signal-to-Noise ratio (SNR).

4. The wireless transmission device of claim 3, further comprising a memory configured to store a matching table matching a corresponding relationship between the SNR and the compression ratio, and
wherein the processor is configured to determine the compression ratio that matches the SNR from the matching table

5. The wireless transmission device of claim 4, wherein the matching table further includes a corresponding relationship between the compression ratio and the number of transmission antennas to be turned on, and
the processor is configured to determine the number of transmission antennas to be turned on that matches the compression ratio from the matching table, and turn on the determined number of transmission antennas.

6. The wireless transmission device of claim 4, wherein the matching table further includes a corresponding relationship between the compression ratio and a gain of the transmission antenna, and
the processor is configured to determine the gain that matches the compression ratio from the matching table and control the plurality of transmission antennas to have the determined gain.

7. The wireless transmission device of claim 4, wherein the processor is configured to:
if the compression ratio is greater than or equal to a first reference compression ratio, turn on N transmission antennas among the plurality of transmission antennas, and
if the compression ratio is less than the first reference compression ratio, turn on more than N transmission antennas among the plurality of transmission antennas.

8. A wireless display system including a wireless transmission device and a wireless reception device,
wherein the wireless transmission device is configured to obtain coverage data, determine a compression ratio of the image signal based on the obtained coverage data, determine values of one or more setting parameters corresponding to the determined compression ratio, set a plurality of transmission antennas according to the determined values of the one or more setting parameters, and transmit a compressed image signal to the wireless reception device using the values of the one or more setting parameters, and
wherein the one or more setting parameters includes the number of transmission antennas to be turned on among the plurality of transmission antennas, and
the wireless transmission device is configured to determine the values of the setting parameters so that the number of transmission antennas to be turned on decreases as the determined compression ratio increases,
the wireless reception device is configured to restore the compressed image signal and display an image based on the restored image signal.

9. The wireless display system of claim 8, wherein the one or more setting parameters further include a gain of the plurality of transmission antennas.

10. The wireless display system of claim 9, wherein the coverage data is Signal-to-Noise ratio (SNR).

11. The wireless display system of claim 10, wherein the wireless transmission device further includes a memory configured to store a matching table matching a corresponding relationship between the SNR and the compression ratio, and
determine the compression ratio that matches the SNR from the matching table.

12. The wireless display system of claim 11, wherein the matching table further includes a corresponding relationship between the compression ratio and the number of transmission antennas to be turned on, and
the wireless transmission device is configured to determine the number of transmission antennas to be turned on that matches the compression ratio from the matching table, and turn on the determined number of transmission antennas.

13. The wireless display system of claim 11, wherein the matching table further includes a corresponding relationship between the compression ratio and a gain of the transmission antenna, and
the wireless transmission device is configured to determine the gain that matches the compression ratio from the matching table and control the plurality of transmission antennas to have the determined gain.

14. The wireless display system of claim 8, wherein the wireless transmission device is configured to:
if the compression ratio is greater than or equal to a first reference compression ratio, turn on N transmission antennas among the plurality of transmission antennas, and
if the compression ratio is less than the first reference compression ratio, turn on more than N transmission antennas among the plurality of transmission antennas.

15. The wireless display system of claim 8, wherein the wireless reception device is configured to:
display a guide image that guides a placement position between the wireless transmission device and the wireless reception device so that the compression ratio is greater than or equal to a preset compression ratio.
